(19) United States
(12) Patent Application Publication
(10) Pub. No.: US 2004/0101669 A1
(43) Pub. Date: May 27, 2004

(54) Malti-layer board device for files or cases

(76) Inventor: Jui Yang Chang, Taichung (TW)

Correspondence Address: Jui Yang Chang, P.O. Box 63-298, Taichung, 406, TW

(21) Appl. No.: 10/307,374

(22) Filed: Nov. 26, 2002

(51) Int. Cl. B32B 7/02

(52) U.S. Cl. 428/212

(57) ABSTRACT

A multi-layer board device includes a an inner layer made of foamable materials, two outer layers disposed on two opposite outer sides of the inner layer, and two intermediate layers disposed between the inner layer and the outer layers, for bonding the inner layer between the outer layers. The inner layer may be made of the lighter foamable or waste or recycled materials, and the outer layers may be made of stronger plastic or synthetic materials for solidly retaining the inner layer between the outer layers, and for forming the stronger but lighter board device.

### BACKGROUND OF THE INVENTION

1. Field of the Invention

The present invention relates to a multi-layer board device, and more particularly to a multi-layer board device for making file holders, luggage members, suitcases, etc.

2. Description of the Prior Art

Typical file holding devices, such as document holders, record holders, files, clip boards, record folders, cardboards, leaf binders, organizers, etc., comprise an outer peripheral wall made of paper boards that have a less weight, but, the paper boards are not strong enough and may be easily damaged or bent inadvertently.

The outer covers or walls of the other file holding devices may be made of plastic materials, that may be stronger, but may have a great weight, and that may not be easily carried with the users.

The typical suitcases or luggage members comprise an outer peripheral wall normally made of plastic materials, that may be stronger, but may have a great weight, and that may not be easily carried with the users.

The present invention has arisen to mitigate and/or obviate the afore-described disadvantages of the conventional file holding devices and luggage members.

### SUMMARY OF THE INVENTION

The primary objective of the present invention is to provide a multi-layer board device including a stronger and lighter structure, for forming the outer cover or the outer peripheral wall members of the file holding devices, the suitcases, or the luggage members, etc.

In accordance with one aspect of the invention, there is provided a multi-layer board device comprising an inner layer made of foamable materials, and having two opposite outer sides, two outer layers disposed on the outer sides of the inner layer, and made of plastic materials, and two intermediate layers disposed between the inner layer and the outer layers, to bond and secure the inner layer and the outer layers together, in order to form a stronger by lighter board device that may be used for forming or making various objects, such as the file holding devices, the suitcases, the luggage members, or the like.

The inner layer that is preferably made of foamable materials may thus include a thickness greater than that of the outer layers, and preferably also greater than that of the intermediate layers. The inner layer may preferably be made of recycled and waste materials.

For example, the inner layer includes a thickness of 75% of the multi-layer board device, the outer layers include a thickness of 25% of the multi-layer board device, and the intermediate layers include a thickness of 5% of the multi-layer board device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a suitcase or luggage member formed by a multi-layer board device in accordance with the present invention;

FIG. 2 is a cross sectional view taken along lines 2-2 of FIG. 1;

FIG. 3 is an enlarged partial cross sectional view of the multi-layer board device;

FIG. 4 is an enlarged partial perspective view of the multi-layer board device, in which a portion of the layers of the board device is cut off; and

FIGS. 5, 6, 7, 8 are perspective views illustrating the other objects, such as the cases, the file holding devices, etc., that may also be formed or made with the multi-layer board device in accordance with the present invention.

### DETAILED DESCRIPTION OF THE PREFERRED EMBODIMENT

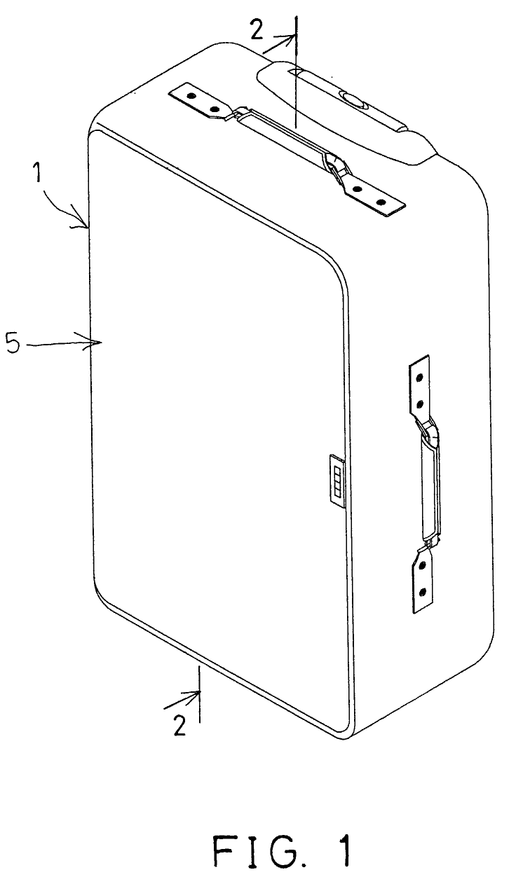

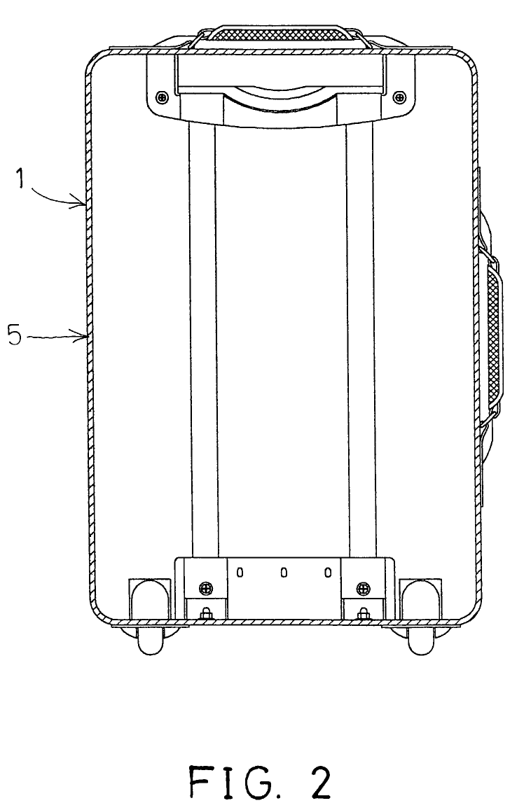

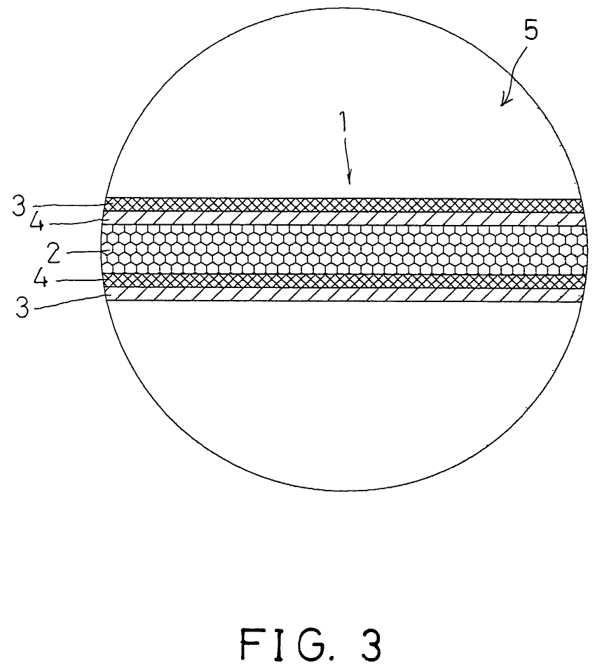

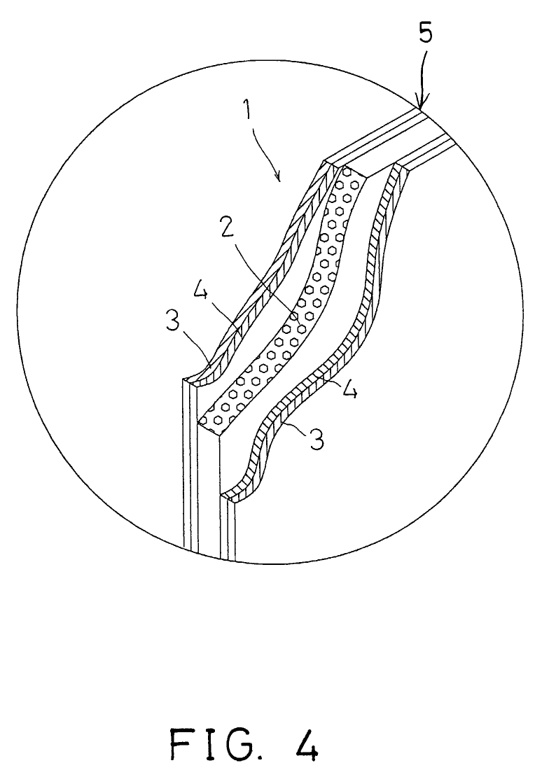

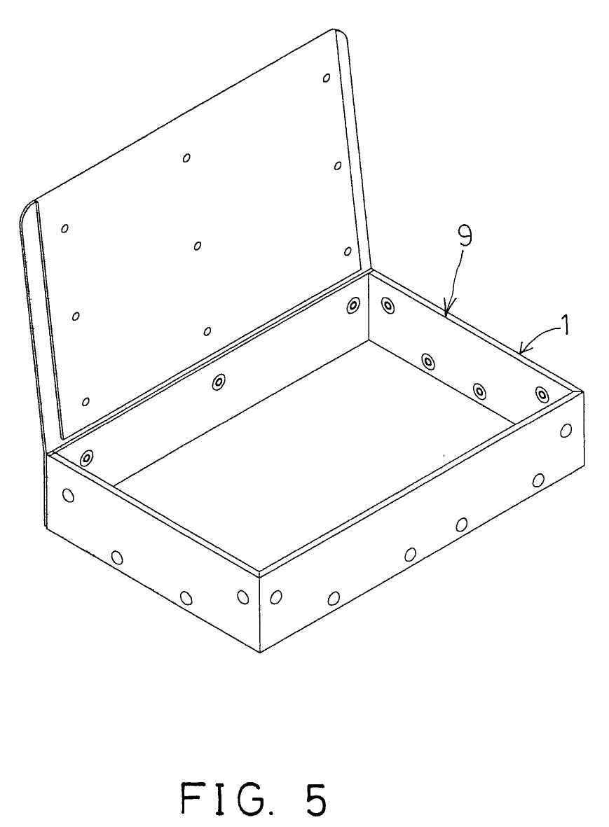

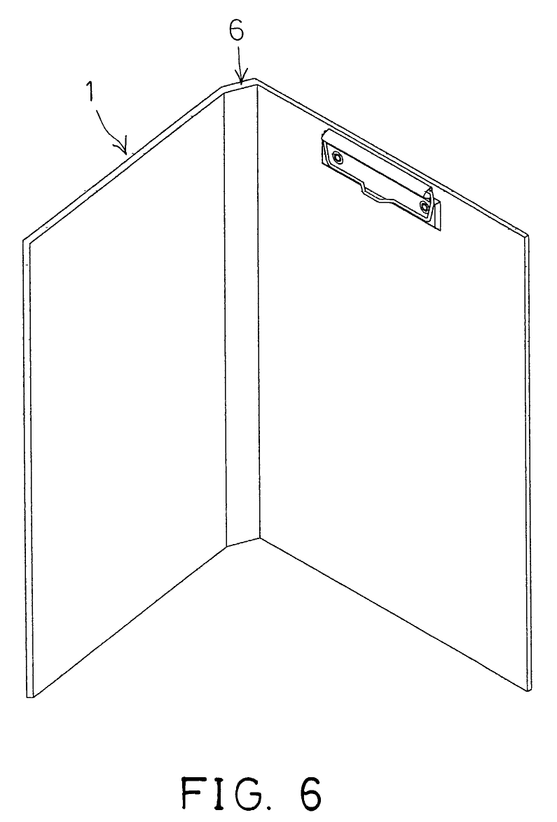

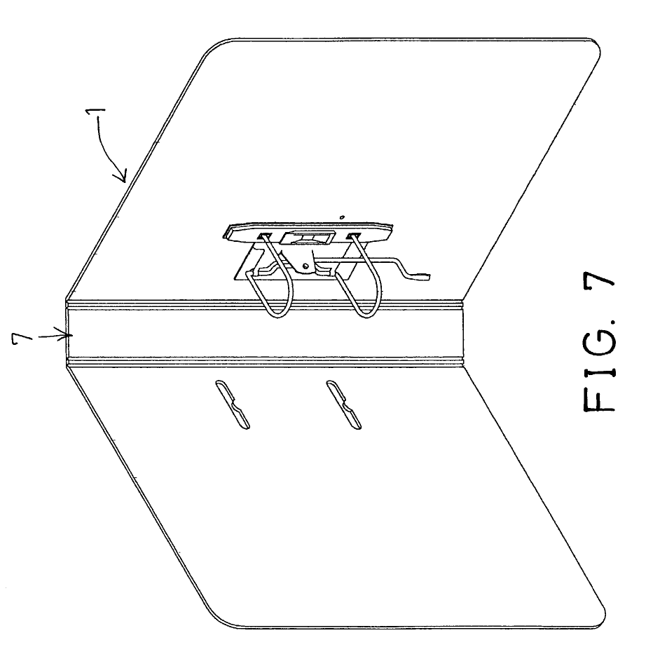

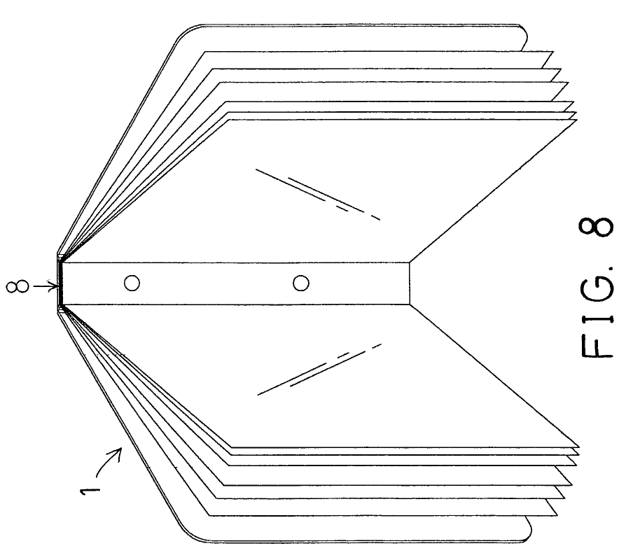

Referring to the drawings, and initially to FIGS. 1-4, a multi-layer board device 1 in accordance with the present invention may be provided for manufacturing or forming or making the objects, such as the luggage members 5 as shown in FIGS. 1 and 2, the case 9 as shown in FIG. 5, or the file holding devices 6, 7, 8 as shown in FIGS. 6-8). Particularly, the multi-layer board device 1 may be provided for forming such as the outer peripheral wall or the cover of the objects 5-9.

The multi-layer board device 1 comprises an inner layer 2, two outer layers 3 disposed on the opposite outer sides of the inner layer 2, and two intermediate layers 4 disposed between the inner layer 2 and the outer layers 3 respectively, for allowing the inner layer 2 to be disposed or clamped or retained between the outer layers 3 and the intermediate layers 4.

The inner layer 2 is preferably made of spongy or foamable materials, or the other synthetic materials, such as acrylonitrile butadiene styrene+polycarbonate (ABS+PC), polyamide (PA), polycarbonate (PC), polyethylene (PE), polyethylene terephthalate (PET), polypropylene (PP), polystyrene (PS), polyvinyl chloride (PVC), ethylene-vinyl acetate copolymer (EVA), etc.

The inner layer 2 include a light or less weight, and includes a thickness preferably greater than that of the outer layers 3 and the intermediate layers 4. The inner layer 2 thus may be softer but thicker than the outer layers 3 and the intermediate layers 4, and may have two opposite outer sides engaged with or secured or bonded to the inner sides of the intermediate layers 4.

The outer layers 3 may also be made of plastic materials, or the other synthetic materials, that have a greater weight than that of the inner layer 2, such as polyamide (PA), polycarbonate (PC), polyethylene (PE), polyethylene terephthalate (PET), polyoxy methylene (POM), polypropylene (PP), polystyrene (PS), ethylene-vinyl acetate copolymer (EVA), etc.

The two outer layers 3 are stronger than the inner layer 2 and each preferably includes a thickness smaller than that of the inner layer 2, but preferably heavier than the inner layer 2. For allowing the inner layer 2 and the outer layers 3 to be solidly secured or bonded together, two further intermediate layers 4 are provided and disposed between the inner layer 2 and the outer layers 3 respectively.

Accordingly, the intermediate layers 4 are preferably made of synthetic materials, that may suitably adhere or secure or bond the inner layer 2 and the outer layers 3 together, such as thermoplastic elastomeric (TPE) materials, etc.

While manufacturing the multi-layer board device 1, the inner layer 2, the outer layers 3 and the intermediate layers 4 are preferably synchronously ejected or extruded with three machines, such as three extruding machines (not shown), for allowing the layers 2, 3, 4 to be secured or bonded together before the materials for forming the layers 2, 3, 4 are cured or hardened.

The extruding machines may be arranged to extrude or to form the inner layer 2 including a thickness of about or occupying 75% of the multi-layer board device 1, and to form the outer layers 3 including a thickness of about or occupying 25% of the multi-layer board device 1, and to form the intermediate layers 4 including a thickness of about or occupying 5% of the multi-layer board device 1.

The inner layer 2 may preferably be made or formed with the recycled or waste materials that may also have a weight less than that of the two outer layers 3, 4, for allowing the board device 1 to have a decreased weight, about 30-50% less than that of the typical covers or board members for the file holding devices or the suitcases or the luggage members, and the other objects.

It is to be noted that the outer layers 3, the intermediate layers 4 and the inner layer 2 may be made of similar plastic or synthetic materials that may include vulcanizing agents of different proportions, for allowing the inner layer 2 to be softer than the outer layers 3, and the intermediate layers 4, and for allowing the layers 2, 3, 4 to be formed and bonded and secured together with three extruding machines.

Accordingly, the multi-layer board device in accordance with the present invention includes a stronger but lighter structure, for allowing the objects or file holding devices or suitcases or luggage members to have a less weight and to be easily carried with or by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A multi-layer board device comprising:
an inner layer made of foamable materials, and having two opposite outer sides,
two outer layers disposed on said outer sides of said inner layer, and made of plastic materials, and
two intermediate layers disposed between said inner layer and said outer layers, to bond and secure said inner layer and said outer layers together.

2. The multi-layer board device according to claim 1, wherein said inner layer includes a thickness greater than that of said outer layers.

3. The multi-layer board device according to claim 1, wherein said inner layer includes a thickness greater than that of said intermediate layers.

4. The multi-layer board device according to claim 1, wherein said inner layer includes a thickness of 75% of said multi-layer board device, said outer layers include a thickness of 25% of said multi-layer board device, and said intermediate layers include a thickness of 5% of said multi-layer board device.

5. The multi-layer board device according to claim 1, wherein said inner layer is made of recycled and waste materials.
